(19) United States
(12) Patent Application Publication
(10) Pub. No.: US 2011/0273423 A1
(43) Pub. Date: Nov. 10, 2011

(54) LIQUID CRYSTAL DISPLAY PANEL

(76) Inventors: Pai-Hung Hsu, Hsin-Chu (TW); Ming-Chin Lee, Hsin-Chu (TW)

(21) Appl. No.: 13/038,396

(22) Filed: Mar. 2, 2011

(30) Foreign Application Priority Data
May 6, 2010 (TW) 099114505

(51) Int. Cl. G09G 3/36; G06F 3/038

(52) U.S. Cl. 345/211; 345/90

(57) ABSTRACT

A liquid crystal display panel includes an array substrate and at least a conducting wire. The conducting wire, disposed in a peripheral region of the array substrate, includes a first straight section, and a second straight section structurally connected to the first straight section. At least one side of the first straight section is arranged along a first direction, and at least a side of the second straight section is arranged along a second direction, where the first direction and the second direction are non-parallel. The first straight section includes a plurality of first slits arranged along the first direction, and the second straight section includes a plurality of second slits arranged along the second direction.

### BACKGROUND OF THE INVENTION

1. Field of the Invention

The present invention relates to a liquid crystal display panel, and more particularly, to a liquid crystal display panel with a low resistant conducting wire.

2. Description of the Prior Art

“Narrow bezel” is one of the trendy designs of flat display device. To meet the narrow bezel design, it is common to overlap the light-shielding layer (BM), the sealant and the conducting wires in the vertical projection direction in the peripheral region in the design of liquid crystal display panel. The sealant of liquid crystal display panel is light-curable sealant, e.g. UV curable sealant, and thus has to be irradiated by light to provide the adhesion between the array substrate and the color filter substrate, and to seal the liquid crystal molecules therebetween. As the light-shielding layer disposed in the color filter substrate does not allow light to pass, the sealant must be irradiated by the light emitting from the array substrate side. The conducting wire, however, is normally made of metal which is light-shielding, and thus the light can only pass through the space between adjacent conducting wires. In such case, the sealant cannot be effectively due to insufficient light.

In order to improve the amount of light irradiating on the sealant in the irradiation process, a conventional method proposes forming openings in the conducting wires. This method increases the amount of light in the irradiation process, but raises the resistance of the conducting wires, thereby increasing the risk of burning down the conducting wires.

### SUMMARY OF THE INVENTION

It is therefore one of the objectives of the present invention to provide a liquid crystal display panel to increase the irradiation of sealant while remaining the low resistance of the conducting wire.

According to the present invention, a liquid crystal display panel is provided. The liquid crystal display panel includes an array substrate, and at least one conducting wire. The array substrate includes a peripheral region. The conducting wire is disposed in the peripheral region of the array substrate, wherein the conducting wire includes a first straight section, and a second straight section structurally connected to the first straight section. At least one side of the first straight section is arranged along a first direction, at least one side of the second straight section is arranged along a second direction, the first direction and the second direction are non-parallel to each other, and a connection point of the at least one side of the first straight section and the at least one side of the second straight section forms a turning point. The first straight section includes a plurality of first branches arranged along the first direction, and a plurality of first slits formed between adjacent first branches. The second straight section includes a plurality of second branches arranged along the second direction, and a plurality of second slits formed between adjacent second branches. Each of the first slits is parallel to the first direction, and each of the second slits is parallel to the second direction.

According to the present invention, a liquid crystal display panel is provided. The liquid crystal display panel includes an array substrate, at least one conducting wire and a plurality of first compensating lines. The array substrate includes a peripheral region. The conducting wire is disposed in the peripheral region of the array substrate, wherein the conducting wire includes a first straight section, and at least one side of the first straight section is arranged along a first direction. The first straight section includes a plurality of first branches arranged along the first direction, and a plurality of first slits formed between adjacent first branches, and each of the first slits is parallel to the first direction. The first compensating lines intersect and electrically connect to the first branches of the first straight section, wherein the first slits form a plurality of first slots by intersecting the first compensating lines and the first branches of the first straight section, each of the first slots has a long axis and a short axis, and the long axis is larger than the short axis.

In the present invention, the slits and the slots having a long axis larger than a short axis are arranged parallel to the main current path, and thus the conducting wire has low resistance even when the aperture ratio of the conducting wire increases. Consequently, the breakdown risk of the conducting wire is reduced.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a liquid crystal display panel according to a first preferred embodiment of the present invention.

FIG. 2 is a sectional view of the conducting wire shown in FIG. 1.

FIG. 3 is a sectional view of the conducting wire shown in FIG. 1 according to a second preferred embodiment of the present invention.

FIG. 4 is a sectional view of the conducting wire shown in FIG. 1 according to a third preferred embodiment of the present invention.

FIG. 5 is a sectional view of a conducting wire in which the slits is non-parallel to the main current path.

### DETAILED DESCRIPTION

To provide a better understanding of the present invention, preferred embodiments will be made in details. The preferred embodiments of the present invention are illustrated in the accompanying drawings with numbered elements.

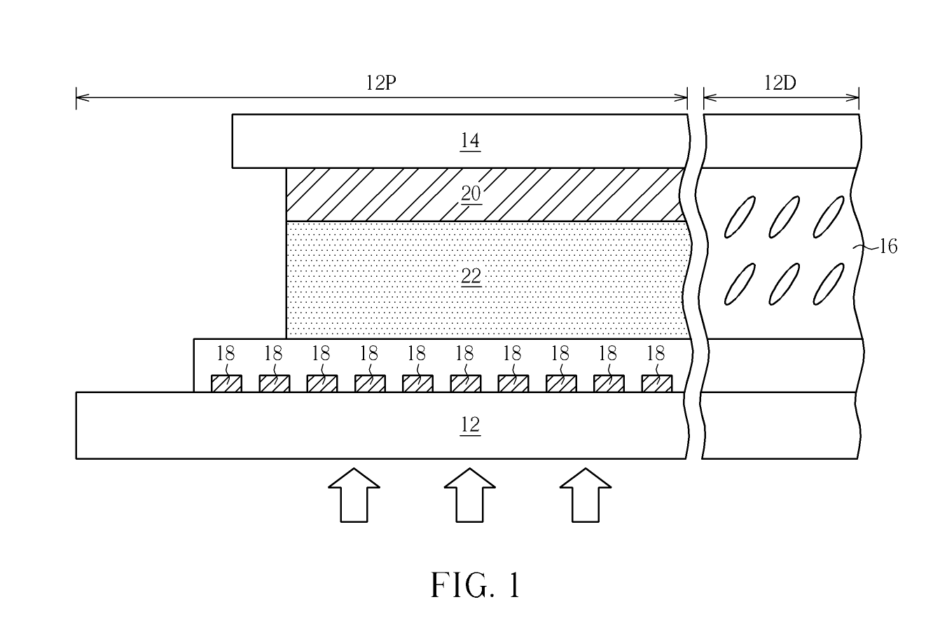

Please refer to FIG. 1. FIG. 1 is a schematic diagram illustrating a liquid crystal display panel according to a first preferred embodiment of the present invention. As shown in FIG. 1, the liquid crystal display panel 10 includes an array substrate 12, a color filter (CF) substrate 14 disposed oppositely to the array substrate 12, and a liquid crystal layer 16 interposed between the array substrate 12 and the CF substrate 14. The array substrate 12 includes a display region 12D, and a peripheral region 12P surrounding the display region 12D defined thereon. The array substrate 12 further includes pixel structures (not shown) formed by components such as gate lines, data lines, thin film transistors, storage capacitors and pixel electrodes in the display region 12D, and a plurality of conducting wires 18 disposed in the peripheral region 12P. The conducting wires 18 are used to transit any signals that the liquid crystal display panel 10 requires such as gate signals, data signals, and common signals. The CF substrate 14 includes a light-shielding layer 20 corresponding to the peripheral region 12P of the array substrate 12, and devices such as color filters (not shown) corresponding to the display region 12D of the array substrate 12. The liquid crystal display panel 10 further includes a light-curable sealant 22 formed between the array substrate 12 and the CF substrate 14. The array substrate 12 and the CF substrate 14 are bonded by the light-curable sealant 22, and the liquid crystal layer 16 is enclosed between the array substrate 12 and the CF substrate 14 by the light-curable sealant 22. As shown in FIG. 1, in the peripheral region 12P, the light-curable sealant 22 and the light-shielding layer 20 are disposed on the conducting wires 18, and the light-curable sealant 22 and the light-shielding layer 20 at least partially overlap with the conducting wires 18. The light-curable sealant 22 needs to be irradiated by light to provide adhesion between the array substrate 12 and the CF substrate 14. The light-shielding layer 20, however, does not allow light to pass, and thus the light (indicated by the arrows in FIG. 1) used to irradiate the light-curable sealant 22 is emitted through the array substrate 12.

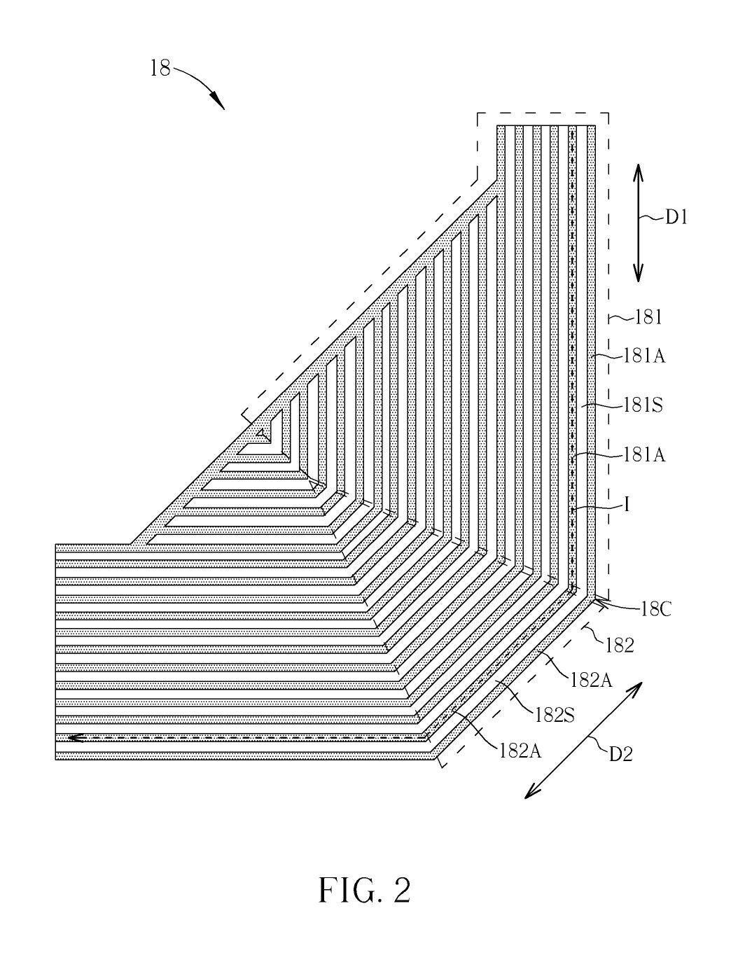

Please refer to FIG. 2, as well as FIG. 1. FIG. 2 is a sectional view of the conducting wire shown in FIG. 1. As shown in FIG. 2, the conducting wire 18 includes a first straight section 181, and a second straight section 182 structurally connected to the first straight section 181. At least one side of the first straight section 181 is arranged along a first direction D1, and at least one side of the second straight section 182 is arranged along a second direction D2. The first direction D1 and the second direction D2 are non-parallel, i.e. the included angle between the first direction D1 and the second direction D2 is larger than 0 degree and less than 180 degrees. Accordingly, the connection point of the at least one side of the first straight section 181 (e.g. the outer side of the first straight section 181) and the at least one side of the second straight section 182 (e.g. the outer side of the second straight section 182) forms a turning point 18C. In addition, the first straight section 181 includes a plurality of first branches 181A arranged along the first direction D1, and a plurality of first slits 181S formed between adjacent first branches 181A; the second straight section 182 includes a plurality of second branches 182A arranged along the second direction, and a plurality of second slits 182S formed between adjacent second branches. Each of the first slits 181S is parallel to the first direction D1, and each of the second slits 182S is parallel to the second direction D2. Furthermore, in this embodiment, the two outer sides of the conducting wire 18 are substantially parallel throughout the whole conducting wire 18, but not limited thereto.

In this embodiment, the conducting wire 18 is made of material with good conductivity e.g. metal, which is opaque. However, the first slits 181S of the first straight section 181 and the second slits 182S of the second straight section 182 allow light to penetrate, and thus the light used to irradiate and cure the light-curable sealant 22 can be increased. In addition, in the process of current transmission in the conducting wire 18, the main current path I (indicated by the arrow drawn by dotted line) is along the first direction D1 in the first straight section 181 and along the second direction D2 in the second straight section 182. Since the first branches 181A and the first slits 181S are arranged parallel to the first direction D1 and the second branches 182A and the second slits 182S are parallel to the second direction D2, current can fluently and successively pass through the first branches 181A and the second branches 182A. Consequently, the conducting wire 18 has low resistance.

The conducting wire of the liquid crystal display panel is not limited to the aforementioned embodiment, and different embodiments will be illustrated in the following passages. In order to compare the differences between different embodiments, same components are denoted by same numerals, and repeated parts are not redundantly described.

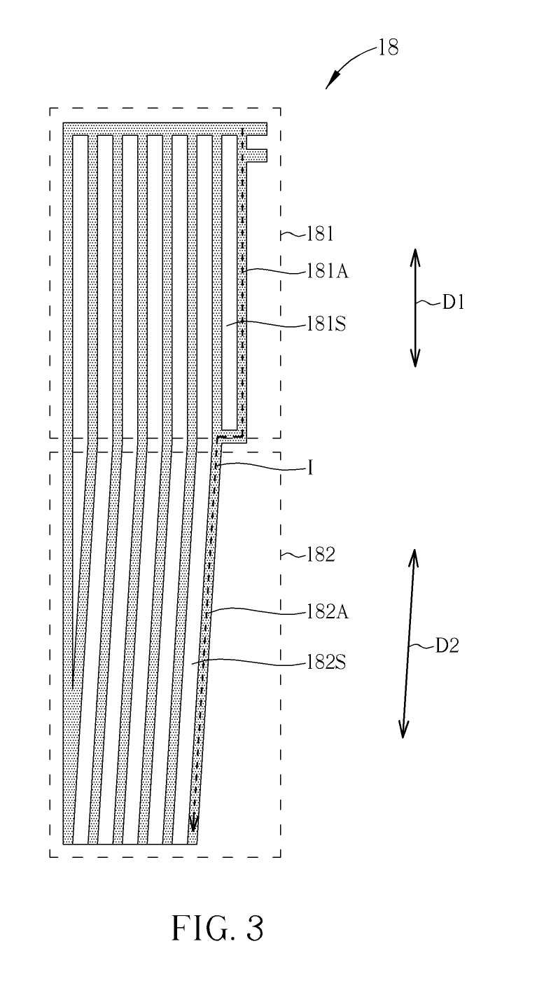

Please refer to FIG. 3, as well as FIG. 1. FIG. 3 is a sectional view of the conducting wire according to a second preferred embodiment of the present invention. As shown in FIG. 3, different from the first embodiment, the conducting wire 18 of the present embodiment may have different line width in some section. For instance, the two outer sides of the first straight section 181 of the conducting wire 18 are parallel to the first direction D1, and the first branches 181A and the first slits 181S are parallel to the two outer sides of the first straight section 181; the two outer sides of the second straight section 182 are not parallel, and the second branches 182A and the second slits 182S are parallel to only one of the outer side of the second straight section 182 (also parallel to the second direction D2). Similarly, the main current path I (indicated by the arrow drawn by dotted line) is along the first direction D1 in the first straight section 181 and along the second direction D2 in the second straight section 182, and thus the conducting wire 18 has low resistance.

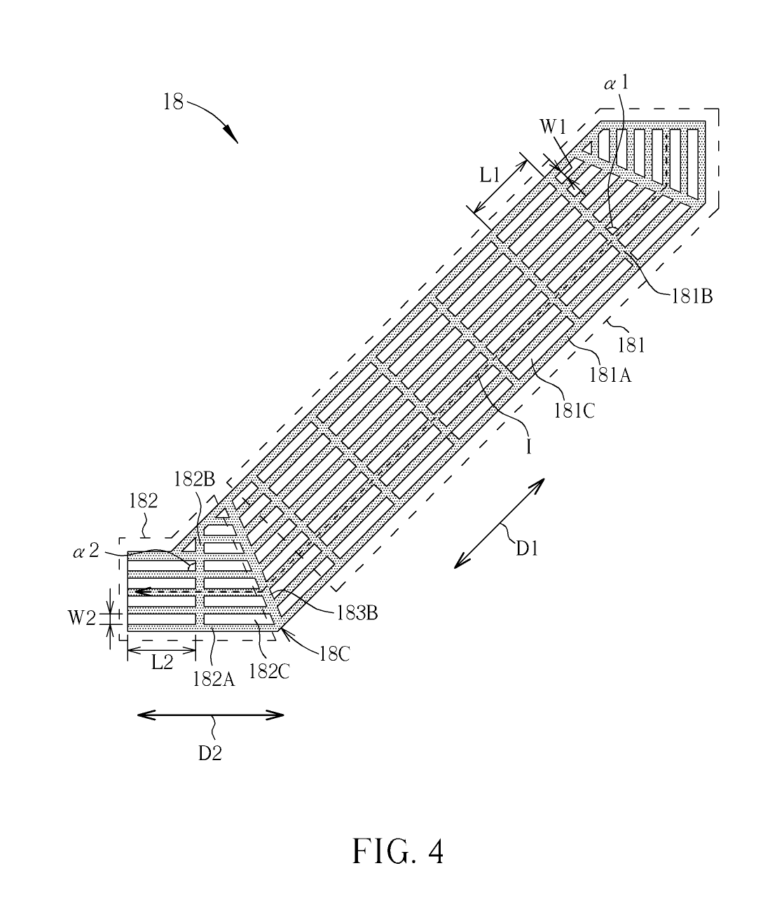

Please refer to FIG. 4, as well as FIG. 1. FIG. 4 is a sectional view of the conducting wire according to a third preferred embodiment of the present invention. As shown in FIG. 4, different from the first embodiment, the conducting wire 18 of the present embodiment further includes a plurality of first compensating lines 181B and a plurality of second compensating lines 182B. The first compensating lines 181B intersect and electrically connect to the first branches 181A of the first straight section 181, and the second compensating lines 182B intersect and electrically connect to the second branches 182A of the second straight section 182. In this embodiment, an included angle α1 between the first compensating lines 181B and the first branches 181A of the first straight section 181 is substantially larger than 0 degree and less than or equal to 90 degrees. For example, the first compensating lines 181B and the first straight branches 181A of the first straight section 181 may be intersected perpendicularly, but not limited thereto. Accordingly, the first slits 181S may form a plurality of first slots 181C due to the arrangement of the first compensating lines 181B. The first compensating lines 181B may be arranged in parallel or along different directions. An included angle α2 between the second compensating lines 182B and the second branches 182A of the second straight section 182 is substantially larger than 0 degree and less than or equal to 90 degrees. For example, the second compensating lines 182B and the second branches 182A of the second straight section 182 may be intersected perpendicularly, but not limited thereto. Accordingly, the second slits 182S may form a plurality of second slots 182C due to the arrangement of the second compensating lines 182B. The second compensating lines 182B may be arranged in parallel or along different directions. In addition, the conducting wire 18 may further includes at least one third compensating line 183B near the turning point 18C. The third compensating line 183B may be arranged parallel to or non-parallel to the first compensating lines 181B or the second compensating lines 182B.

In this embodiment, each of the first slots 181C and each of the second slots 182C is a non-square slot. A long axis L1 of each first slot 181C is parallel to the first direction D1, and a short axis W1 of each first slot 181C is perpendicular to the first direction D1. A long axis L2 of each second slot 182C is parallel to the second direction D2, and a short axis W2 of each second slot 182C is perpendicular to the second direction D2. The first compensating lines 181B and the second compensating lines 182B are able to increase the path for transmitting current, such that the breakdown risk when large current passes through the first branches 181A and the second branches 182A having smaller line width may be reduced.

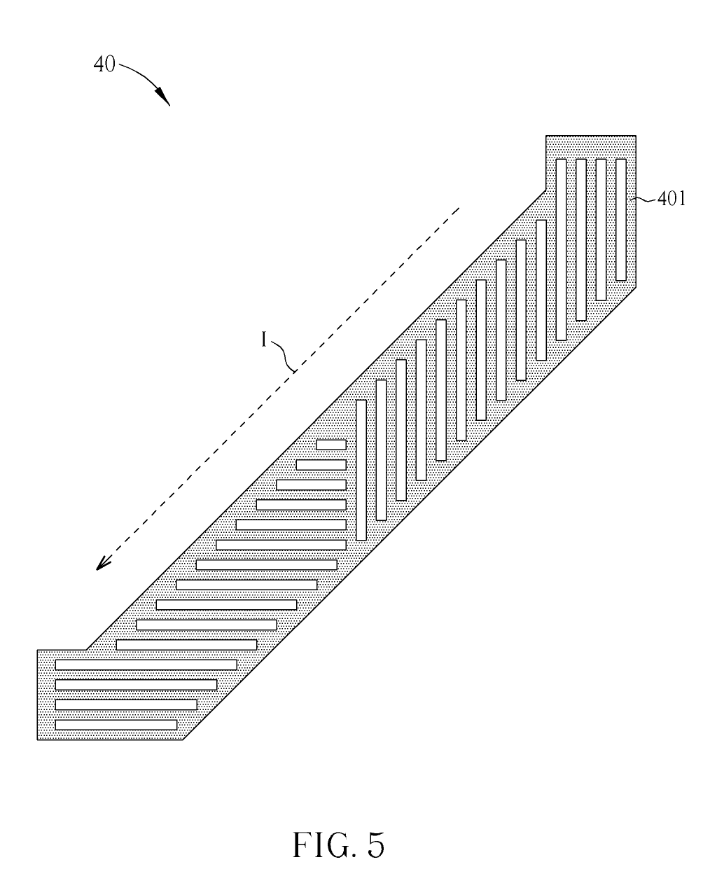

Please refer to FIG. 5. FIG. 5 is a sectional view of a conducting wire in which the slits is non-parallel to the main current path. As shown in FIG. 5, the conducting wire 40 includes a plurality of slits 401. The slits 401 are arranged non-parallel to the main current path I (indicated by the arrow drawn by dotted line), and thus the resistance of the conducting wire 40 is expected to be high.

Please refer to Table 1. Table 1 lists the simulation result of resistance of the conducting wires of FIG. 4 and FIG. 5. As shown in Table 1, with identical signals and identical line width and line pitch (the pitch of slit or the width of slot) and when the experimental error is under 2%, the resistance in the experimental group (the conducting wire shown in FIG. 4) is significantly lower than the resistance in the control group (the conducting wire shown in FIG. 5). Relative to the control group, the degree of resistance decrease of the experimental group is found to be in the range of 23.42% to 73.66%, and the average degree of resistance decrease is about 49%. The simulation result proves that the conducting wire of the present invention has lower resistance, and thus the electrical transmission of the liquid crystal display panel can be effectively improved.

TABLE 1

| Error: 2% | Types of conducting wire | | Resistance |
|---|---|---|---|
| Unit: ohm | Experimental group | Control group | improvement |
| Sample 1 | 0.75 | 1.26 | 40.48% |
| Sample 2 | 1.83 | 3.87 | 52.71% |
| Sample 3 | 0.9 | 1.92 | 53.13% |
| Sample 4 | 0.98 | 3.72 | 73.66% |
| Sample 5 | 1.02 | 1.332 | 23.42% |

In conclusion, the slits and the slots having a long axis larger than a short axis of the present invention are arranged parallel to the main current path, and thus the conducting wire has low resistance even when the aperture ratio of the conducting wire increases. Consequently, the breakdown risk of the conducting wire is reduced.

Those skilled in the art will readily observe that numerous modifications and alterations of the device and method may be made while retaining the teachings of the invention.

What is claimed is:

1. A liquid crystal display panel, comprising:
an array substrate comprising a peripheral region; and
at least one conducting wire disposed in the peripheral region of the array substrate, wherein the conducting wire comprises a first straight section, and a second straight section structurally connected to the first straight section, at least one side of the first straight section is arranged along a first direction, at least one side of the second straight section is arranged along a second direction, the first direction and the second direction are non-parallel to each other, a connection point of the at least one side of the first straight section and the at least one side of the second straight section forms a turning point, the first straight section comprises a plurality of first branches arranged along the first direction, and a plurality of first slits formed between adjacent first branches, the second straight section comprises a plurality of second branches arranged along the second direction, and a plurality of second slits formed between adjacent second branches, each of the first slits is parallel to the first direction, and each of the second slits is parallel to the second direction.

2. The liquid crystal display panel of claim 1, wherein the conducting wire further comprises a plurality of first compensating lines and a plurality of second compensating lines, the first compensating lines intersect and electrically connect to the first branches of the first straight section, and the second compensating lines intersect and electrically connect to the second branches of the second straight section.

3. The liquid crystal display panel of claim 2, wherein the first slits form a plurality of first slots by intersecting the first compensating lines and the first branches of the first straight section, and the second slits form a plurality of second slots by intersecting the second compensating lines and the second branches of the second straight section.

4. The liquid crystal display panel of claim 3, wherein the first compensating lines and the first branches of the first straight section are intersected perpendicularly, and the second compensating lines and the second branches of the second straight section are intersected perpendicularly.

5. The liquid crystal display panel of claim 3, wherein each of the first slots has a long axis and a short axis, and the long axis is larger than the short axis.

6. The liquid crystal display panel of claim 3, wherein each of the second slots has a long axis and a short axis, and the long axis is larger than the short axis.

7. The liquid crystal display panel of claim 1, further comprising a light-curable sealant and a light-shielding layer disposed on the conducting wire, wherein the light-curable sealant and the light-shielding layer at least partially overlap with the conducting wire.

8. The liquid crystal display panel of claim 7, further comprising a color filter substrate and a liquid crystal layer, wherein the color filter substrate and the array substrate are disposed oppositely and bonded by the light-curable sealant, and the liquid crystal layer is interposed between the array substrate and the color filter substrate, and the liquid crystal layer is enclosed by the light-curable sealant.

9. A liquid crystal display panel, comprising:
an array substrate comprising a peripheral region;
at least one conducting wire disposed in the peripheral region of the array substrate, wherein the conducting wire comprises a first straight section, at least one side of the first straight section is arranged along a first direction, the first straight section comprises a plurality of first branches arranged along the first direction, and a plurality of first slits formed between adjacent first branches, and each of the first slits is parallel to the first direction; and
a plurality of first compensating lines intersecting and electrically connecting to the first branches of the first straight section, wherein the first slits form a plurality of first slots by intersecting the first compensating lines and the first branches of the first straight section, each of the first slots has a long axis and a short axis, and the long axis is larger than the short axis.

10. The liquid crystal display panel of claim 9, wherein the first compensating lines and the first branches of the first straight section are intersected perpendicularly.

11. The liquid crystal display panel of claim 9, wherein the conducting wire further comprises a second straight section structurally connected to the first straight section, at least one side of the second straight section is arranged along a second direction non-parallel to the first direction, a connection point of the at least one side of the first straight section and the at least one side of the second straight section forms a turning point, the second straight section comprises a plurality of second branches arranged along the second direction, and a plurality of second slits formed between adjacent second branches, and each of the second slits is parallel to the second direction.

12. The liquid crystal display panel of claim 11, further comprising a plurality of second compensating lines, wherein the second compensating lines intersect and electrically connect to the second branches of the second straight section, and the second slits form a plurality of second slots by intersecting the second compensating lines and the second branches of the second straight section.

13. The liquid crystal display panel of claim 12, wherein the second compensating lines and the second branches of the second straight section are intersected perpendicularly.

14. The liquid crystal display panel of claim 12, wherein each of the second slots has a long axis and a short axis, and the long axis is larger than the short axis.

15. The liquid crystal display panel of claim 9, further comprising a light-curable sealant and a light-shielding layer disposed on the conducting wire, wherein the light-curable sealant and the light-shielding layer at least partially overlap with the conducting wire.

16. The liquid crystal display panel of claim 15, further comprising a color filter substrate and a liquid crystal layer, wherein the color filter substrate and the array substrate are disposed oppositely and bonded by the light-curable sealant, and the liquid crystal layer is interposed between the array substrate and the color filter substrate, and the liquid crystal layer is enclosed by the light-curable sealant.
